(19) United States
(12) Patent Application Publication
(10) Pub. No.: US 2006/0049551 A1
(43) Pub. Date: Mar. 9, 2006

(54) Method for producing a thermoplastic resin foamed article

(75) Inventors: Satoshi Hanada, Ichihara-shi (JP); Yoshinori Ohmura, Osaka (JP)

Correspondence Address: FITCH, EVEN, TABIN & FLANNERY, P. O. BOX 65973, WASHINGTON, DC, 20035, US

(73) Assignees: Sumitomo Chemical Company, Limited, Tokyo (JP); Sumika Plastech Co., Ltd., Tokyo (JP)

(21) Appl. No.: 11/209,762

(22) Filed: Aug. 24, 2005

(30) Foreign Application Priority Data
Aug. 21, 2004 (JP) 2004-251731
Sep. 17, 2004 (JP) 2004-271232

(51) Int. Cl. B29C 51/10

(52) U.S. Cl. 264/553; 264/322

(57) ABSTRACT

Disclosed are methods for producing thermoplastic resin foamed articles having a high expansion ratio and a large thickness by vacuum forming using a pair of molds through which vacuum sucking can be conducted and holding means for holding a thermoplastic resin foamed sheet at a predetermined position between the molds or a molding apparatus comprising a first mold having a molding surface through which vacuum sucking can be conducted, a second mold having a molding surface provided with sheet fixing means on at least the peripheral portion of the molding surface, and holding means for holding a thermoplastic resin foamed sheet at a predetermined position between the molds. In the methods, a heated and softened foamed sheet is supplied between the molds and vacuum sucking is started when the molds have been closed appropriately. Thus, the foamed sheet is vacuum formed to afford a molded article.

### BACKGROUND OF THE INVENTION

1. Field of the Invention

The present invention relates to method for producing thermoplastic resin foamed articles by vacuum forming.

2. Description of the Related Art

Thermoplastic resin foamed articles are superior in lightweight property, recyclability, heat insulation property, etc. and, therefore, are used in various applications such as automotive component materials, building or construction materials and packaging materials.

In many cases of using thermoplastic resin foamed articles in such applications, a thermoplastic resin foamed sheet is produced first and then the foamed sheet is processed into thermoplastic resin foamed articles by shaping of the sheet into a desired shape by secondary forming such as vacuum forming. As a method of vacuum forming of a thermoplastic resin foamed sheet, Japanese Patent Application Publication No. 54-148863, for example, discloses a method of producing a thermoplastic resin foamed article by supplying a thermoplastic resin foamed sheet between a pair of a female and male molds which define a predetermined space when the molds are closed, closing the molds, and vacuum sucking through the molds to shape the foamed sheet into the shape of the space while holding the mold closed.

Foamed sheets are desired to have a high expansion ratio and a large thickness. According to the method mentioned above, it is possible to obtain sheets having a higher expansion ratio and a larger thickness in comparison to unprocessed foamed sheets to be used for vacuum forming. By the above-mentioned method, however, the unprocessed foamed sheets can be expanded only by a volume corresponding to the space formed when the molds are closed. Therefore, resulting thermoplastic resin foamed sheets have a thickness as large as about twice, at most, the thickness of the corresponding unprocessed foamed sheets. The expansion ratio achieved by the method is also unsatisfactory.

For producing thermoplastic resin foamed sheets having a satisfactorily higher expansion ratio and a satisfactorily large thickness in comparison to the corresponding unprocessed foamed sheets, molds having a large space therein must be used by the method. When such molds are used, the space is, in some cases, not filled with an unprocessed foamed sheet even if vacuum sucking is carried out and it is difficult to produce a thermoplastic resin foamed sheet having a higher expansion ratio and a larger thickness in comparison to the unprocessed foamed sheet.

### SUMMARY OF THE INVENTION

The present invention provides methods for producing thermoplastic resin foamed articles having a high expansion ratio and a large thickness.

The present invention provides, in its first aspect, a method for producing a thermoplastic resin foamed article by vacuum forming using a molding apparatus comprising a pair of molds each having a molding surface through which vacuum sucking can be conducted and holding means for holding a thermoplastic resin foamed sheet at a predetermined position between the molds, the method comprising the steps of:
(1) heating a thermoplastic resin foamed sheet to soften it;
(2) supplying the thermoplastic resin foamed sheet softened in step (1) between the molds;
(3) while holding the softened thermoplastic resin foamed sheet with the holding means between the molds, closing the molds until a clearance between the peripheral portions of the molding surfaces of the molds arrives at a predetermined value not greater than the softened thermoplastic resin foamed sheet;
(4) starting vacuum sucking through the molding surfaces of the molds at a point of time during a period from the arrival of the clearance between the peripheral portions of the molding surfaces of the molds at the thickness of the softened thermoplastic resin foamed sheet to the arrival of the clearance at the predetermined value defined in step (3);
(5) while continuing the vacuum sucking, opening the molds until the thermoplastic resin foamed sheet comes to have a predetermined thickness greater than the softened thermoplastic resin foamed sheet at the beginning of step (3), thereby shaping the sheet to produce a molded article; and
(6) a combination of stopping the vacuum sucking, opening the molds and removing the molded article.

The present invention provides, in its second aspect, a method for producing a thermoplastic resin foamed article by vacuum forming using a molding apparatus comprising a first mold having a molding surface through which vacuum sucking can be conducted, a second mold having a molding surface provided with sheet fixing means on at least the peripheral portion of the molding surface, and holding means for holding a thermoplastic resin foamed sheet at a predetermined position between the molds, the method comprising the steps of:
(1) heating a thermoplastic resin foamed sheet to soften it;
(2) supplying the thermoplastic resin foamed sheet softened in step (1) between the first and second molds;
(3) while holding the softened thermoplastic resin foamed sheet with the holding means between the molds, closing the molds until a clearance between the peripheral portions of the molding surfaces of the molds arrives at a predetermined value not greater than the softened thermoplastic resin foamed sheet, thereby bringing the entire area of the molding surface of the second mold into contact with one surface of the foamed sheet;
(4) starting vacuum sucking through the molding surface of the first mold after the entire area of the molding surface of the second mold comes into contact with the surface of the foamed sheet in step (3);
(5) while continuing the vacuum sucking and fixing the sheet on the molding surface of the second mold with the sheet fixing means, opening the molds until the thermoplastic resin foamed sheet comes to have a predetermined thickness greater than the thickness of the softened thermoplastic resin foamed sheet at the beginning of step (3), thereby shaping the sheet to produce a molded article; and
(6) a combination of stopping the vacuum sucking, opening the molds and removing the molded article.

The methods of the present invention can afford thermoplastic resin foamed articles having a high expansion ratio and a great thickness.

### BRIEF DESCRIPTION OF THE DRAWINGS

In the drawings:

FIG. 1 is a diagram which shows one example of the apparatus for producing a thermoplastic resin foamed sheet;

FIG. 2 is a diagram which shows one example of the cross-sectional shape of the circular die for use in the production of a thermoplastic resin foamed sheet;

FIG. 3 is a schematic diagram showing one embodiment of the methods of the present invention for vacuum forming a thermoplastic resin foamed sheet;

FIG. 4 is a schematic diagram showing another embodiment of the methods of the present invention for vacuum forming a thermoplastic resin foamed sheet;

FIG. 5 is a schematic diagram showing another embodiment of the methods of the present invention for vacuum forming a thermoplastic resin foamed sheet;

FIG. 6 is a schematic diagram showing another embodiment of the methods of the present invention for vacuum forming a thermoplastic resin foamed sheet;

FIG. 7 is a schematic diagram showing a conventional method for vacuum forming a thermoplastic resin foamed sheet; and

FIG. 8 is a schematic diagram showing one embodiment of the methods of the present invention for vacuum forming a thermoplastic resin foamed sheet.

The signs in the drawings have meanings shown below: 1: apparatus for producing a thermoplastic resin foamed sheet; 2: 50 mmφ twin screw extruder; 3: 32 mmφ single screw extruder; 4: circular die; 5: pump for supplying carbon dioxide gas; 6: mandrel; 7: head of 50 mmφ twin screw extruder; 8: head of 32 mm single screw extruder; 9a, 9b, 10a, 10b, 10c, 10d, 11a, 11b: passageway; 12: outlet of a circular die; 13: thermoplastic resin foamed sheet; 14: clip; 15: infrared heater; 16, 17, 19, 20, 22, 23: mold; 18: air tightness holding member; 21; air tightness holding member; 24: first mold through which vacuum sucking can be conducted; 25: second mold having sheet fixing means; and 26: sheet fixing means.

### DESCRIPTION OF THE PREFERRED EMBODIMENTS

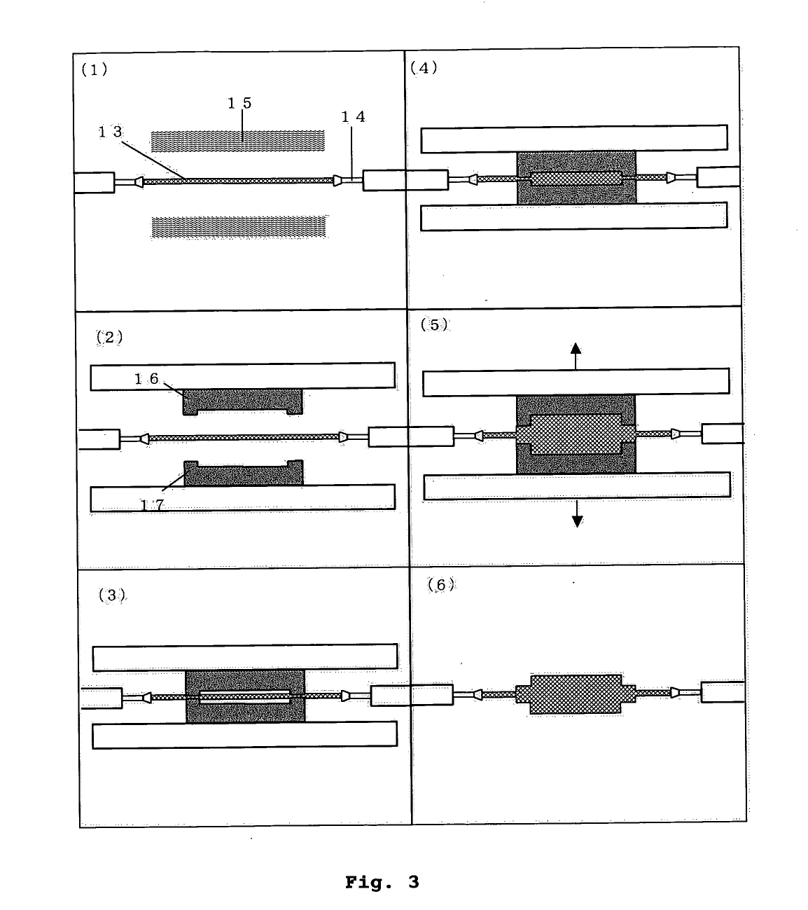

First, embodiments according to the first aspect of the present invention are explained. A typical embodiment is described in detail below with reference to FIG. 3, but the present invention is not limited to this embodiment.

In the present invention, a molding apparatus comprising a pair of opposing molds each having a molding surface through which vacuum sucking can be conducted. Examples of the paired molds include a pair of one male mold and one female mold, a pair of two female molds, and a pair of two flat molds.

Examples of the molds having a molding surface through which vacuum sucking can be conducted include molds each having a molding surface at least part of which is composed of sintered alloy and molds each having a molding surface provided, at least in its restricted section, with one or more holes through which the air is exhausted. The number, location and diameter of the hole or holes with which the molds are provided are not particularly limited if a thermoplastic resin foamed sheet supplied between the molds can be shaped into the shapes of the molding surfaces of the molds.

The molds have no particular limitations on their material, but from the viewpoints of dimensional stability, durability and thermal conductivity, they are normally made of metal. From the viewpoints of cost and weight, the molds are preferably made of aluminum. The molds are preferably structured so that the temperature thereof can be controlled by a heater or heat medium. For improving the lubricity of a foamed sheet or preventing a foamed sheet from cooling before completion of its molding, the molding surfaces of the molds are preferably adjusted within a range of from 30 to 80° C., more preferably from 50 to 60° C. It should be noted that the description in this paragraph is applied also to the embodiments according to the second aspect of the present invention described later.

It is desirable that at least one mold be a mold having an air tightness holding function. Use of such a mold makes it easy to maintain the degree of vacuum in the cavity during vacuum sucking and makes it possible to produce molded articles with extremely less shrinkage. One example of the mold having the air tightness holding function is a mold in which the peripheral portion of its molding surface can move toward the opposing mold. Such a mold preferably has a structure such that the movable portion can be collapsed in the mold so that the top face of the movable portion comes in the same level as the molding surface at the time of mold closure. Use of such a mold makes it easy to maintain the degree of vacuum in the cavity in a mold opening step which is mentioned later because the mold is structured so that the movable portion protrudes as the mold is opened. It should be noted that the description in this paragraph is applied also to the embodiments according to the second aspect of the present invention described later.

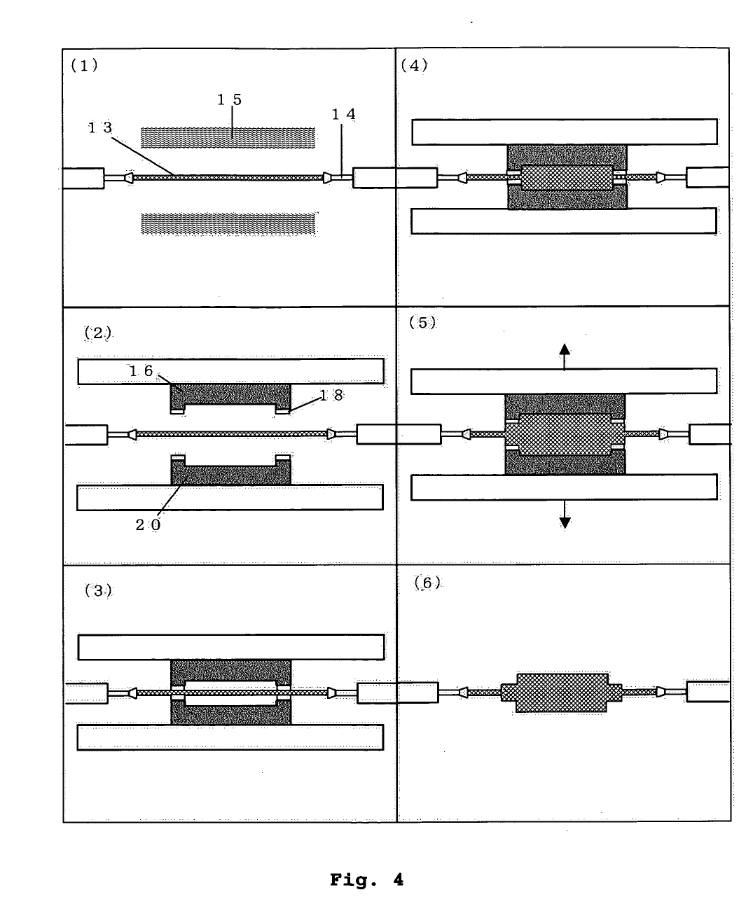

Another example of the mold having the air tightness holding function is a mold having a cushioning material on the peripheral portion of the molding surface as shown in FIG. 4. Foamed sheets normally have minute unevenness on their surfaces. When a mold having a cushioning material is used, it is easy to maintain the degree of vacuum in the cavity when vacuum sucking is carried out because the cushioning material comes into intimate contact with a finely uneven surface of a foamed sheet through mold closure. The cushioning material may be rubber, foam and the like.

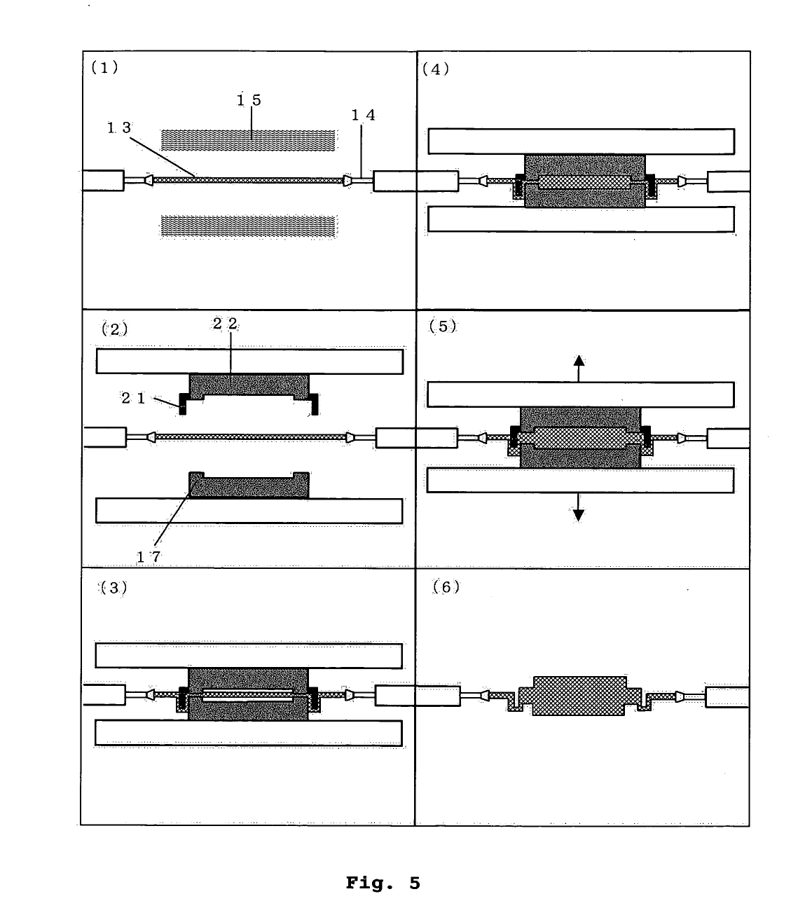

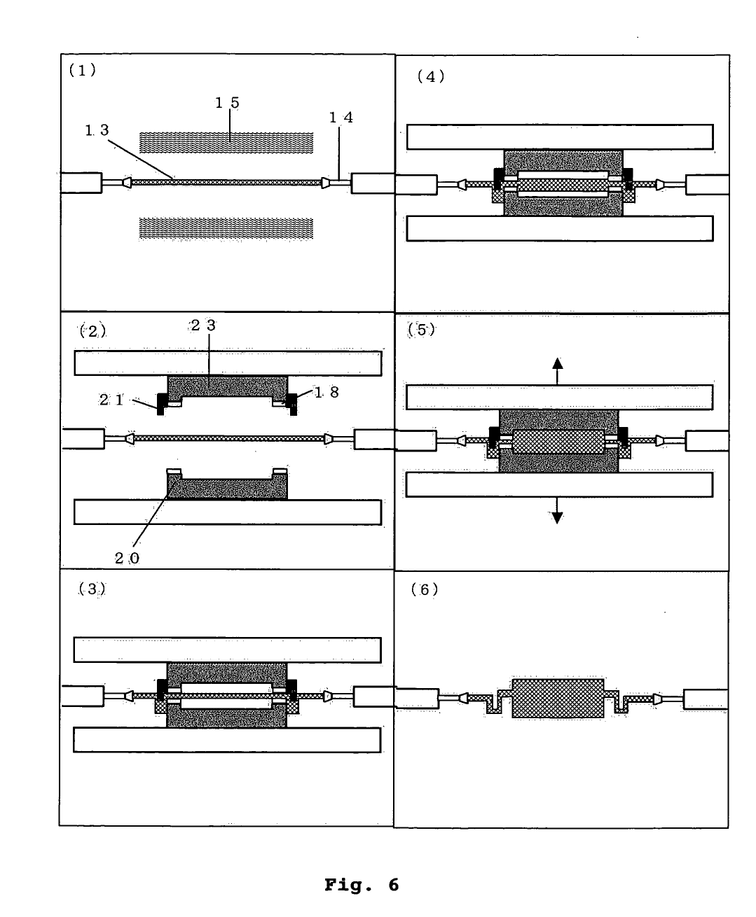

A pair of molds such as those shown in FIG. 5 are also usable wherein one mold is covered, when the molds are closed, with an air tightness holding member provided on the periphery of the other mold.

Molds may have means for fixing a foamed sheet on their molding surfaces and/or the peripheral portions of the molding surfaces. Examples of such means include adhesive, pins, hooks, clips and slits. Use of a mold having such means for fixing a foamed sheet makes it easy to shape a foamed sheet into the shape of the molding surface.

Regarding the molding apparatus, it is desirable to use a molding apparatus such that the molding surfaces of both molds will define therebetween a cavity with a height as high as from 0.8 to 2 times the thickness of the foamed sheet softened in step (1) at the completion of mold closure. The height of a cavity referred to herein means the distance between the molding surfaces corresponding to the thickness direction of the foamed sheet supplied between the molds. The cavity is not required to have the same height at all places in the cavity. The cavity may be any one having a shape corresponding to the shape of a desired molded article. If the height of the cavity defined at completion of mold closure is too small, cells in the foamed sheet may be broken when the molds are closed. If it is too large, as described later, it becomes difficult to shape the foamed sheet by bringing the surfaces of the foamed sheet into contact with the molding surfaces of the molds even if vacuum sucking is carried out. Even if the foamed sheet is brought into contact with the molding surfaces, the foamed sheet becomes susceptible to burst of cells. It should be noted that the description in this paragraph is applied also to the embodiments according to the second aspect of the present invention described later.

FIG. 3-(1) shows step (1) of heating a thermoplastic resin foamed sheet to soften it. In step (1), the foamed sheet is typically held in a clamp frame and heated by a heating device such as a far infrared heater, a near infrared heater, and a contact type hot plate. A far infrared heater is preferably used because it can heat the foamed sheet efficiently in a short time. It is desirable to heat the foamed sheet so that the foamed sheet comes to have a surface temperature near a melting point of the resin constituting the foamed sheet when the resin is crystalline resin or near a glass transition temperature of the resin when the resin is non-crystalline resin. It should be noted that the description in this paragraph is applied also to a corresponding step (shown in FIG. 8-(1)) of the embodiments according to the second aspect of the present invention described later.

FIG. 3-(2) shows a state where the thermoplastic resin foamed sheet softened in step (1) has been supplied between a pair of molds each having a molding surface through which vacuum sucking can be conducted.

FIG. 3-(3) shows a step of closing the molds until a clearance between the peripheral portions of the molding surfaces of the molds arrives at a predetermined value not greater than the softened thermoplastic resin foamed sheet while holding the softened thermoplastic resin foamed sheet with the holding means between the molds. Mold closure is carried out so that the opposing molding surfaces of the molds relatively approach to each other. For example, one mold is fixed and the other is moved toward the fixed one. Alternatively, both molds are moved in opposite directions so that the molds approach to each other.

FIG. 3-(4) shows a state where vacuum sucking is carried out through the molding surfaces of the molds. The vacuum sucking may be started at any point of time during a period from the arrival of the clearance between the peripheral portions of the molding surfaces at the thickness of the softened thermoplastic resin foamed sheet to the arrival of the clearance at a predetermined value not greater than the foamed sheet. For example, it is permissive that vacuum sucking is started at a time when the clearance between the peripheral portions of the molding surfaces becomes equal to the thickness of the softened thermoplastic resin foamed sheet and the molds are further closed to a predetermined thickness smaller than the thickness of the foamed sheet while continuing the vacuum sucking. Alternatively, it is also permissive that vacuum sucking is started at the same time or after the clearance becomes a predetermined thickness not greater than the thickness of the softened thermoplastic resin foamed sheet. When the vacuum sucking is carried out after the foamed sheet comes to have the predetermined thickness, it is usually desirable to start the vacuum sucking before the foamed sheet is cooled and within three seconds from the time when the foamed sheet comes to have the predetermined thickness.

For obtaining a molded article having a uniform internal structure, it is desirable to start vacuum sucking through one mold and vacuum sucking through the other mold simultaneously. However, it is permissive to make a time difference between the starts of the vacuum sucking unless the foamed sheet is cooled. When vacuum sucking through one mold is started after the start of the vacuum sucking through the other mold, the time difference between the starts of the vacuum sucking is preferably within three seconds.

The degree of vacuum sucking is not particularly limited, but it is desirable to suck so that the degree of vacuum in the cavity becomes from −0.05 MPa to −0.1 MPa. The degree of vacuum is a pressure in the cavity with respect to atmospheric pressure. That is, “the degree of vacuum is −0.05 MPa” means that the pressure in the cavity is lower than atmospheric pressure by 0.05 MPa. The higher the degree of vacuum, the more strongly a foamed sheet is attracted to a mold. It, therefore, becomes possible to shape the foamed sheet into a shape closer to the shape of the cavity. The degree of vacuum of a cavity is a value measured at an opening, provided in the cavity, of a hole through which vacuum sucking is conducted. It should be noted that the description in this paragraph is applied also to the embodiments according to the second aspect of the present invention described later.

FIG. 3-(5) shows a state where the molds have been opened until the arrival of the thickness of the thermoplastic resin foamed sheet at a predetermined value greater than the thickness of the softened foamed sheet at the start of the step of closing the molds and, thereby, the sheet has been shaped and a molded article has been formed. The opening of the molds are carried out while the vacuum sucking is continued. The speed of the mold opening and the degree of vacuum during the mold opening may be adjusted so that the foamed sheet is successfully shaped into the shape of a desired molded article.

The foamed sheet is fully cooled while the molds are held open with the predetermined clearance. Then, the vacuum sucking is stopped and the molds are further opened. Finally, a resulting molded article is removed. FIG. 3-(6) shows a state where the molds (not shown) have been opened for the removal of the molded article.

Next, embodiments according to the second aspect of the present invention are explained. A typical embodiment is described in detail below with reference to FIG. 8, but the present invention is not limited to this embodiment.

As shown in FIG. 8, using a first mold (4) having a molding surface through which vacuum sucking can be conducted and a second mold (5) having a molding surface provided with sheet fixing means (6) on at least the peripheral portion of the molding surface, a thermoplastic resin foamed sheet (1) heated and softened with an infrared heater (3) is molded. During this operation, the foamed sheet (1) is fixed with a clip (2), which is holding means. The second mold may be structured so that vacuum sucking can be conducted through its molding surface. Examples of the molds for use in the method include a pair of a male and female molds, two female molds, and a pair of flat molds. Any paired molds may be used if the entire area of the molding surface of the second mold comes into contact with the surface of the foamed sheet when the molds are closed until a clearance between the peripheral portions of the molding surfaces of the molds arrives at a predetermined value not greater than the thickness of the foamed sheet.

Examples of the mold having a molding surface through which vacuum sucking can be conducted include molds having a molding surface at least part of which is composed of sintered alloy and molds having a molding surface provided, at least in its restricted section, with one or more holes through which air is exhausted. The number, location and diameter of the hole or holes with which the molds are provided are not particularly limited if a thermoplastic resin foamed sheet supplied between the molds can be shaped into the shape of the molding surface of the mold.

Another example of the mold having the air tightness holding function is a mold having a cushioning material on the peripheral portion of the molding surface. Foamed sheets normally have minute unevenness on their surfaces. When a mold having a cushioning material is used, it is easy to maintain the degree of vacuum in the cavity when vacuum sucking is carried out because the cushioning material comes into intimate contact with a finely uneven surface of a foamed sheet through mold closure. The cushioning material may be rubber, foam and the like.

A pair of molds are also usable wherein one mold is covered with an air tightness holding member provided on the periphery of the other mold when the molds are closed.

As shown in FIG. 8-(2), the second mold has sheet fixing means (6) on at least the peripheral portion of its molding surface. The sheet fixing means may be provided also on a part of the molding surface. The sheet fixing means may be any means capable of fixing a foamed sheet on the molding surface of the second mold when the molds are opened in step (5), described later, while the vacuum sucking through the molding surface of the first mold is continued. Examples of such means include adhesive, pins, hooks, clips and slits. Use of a mold having such means for fixing a foamed sheet makes it easy to shape a foamed sheet into the shape of the molding surface. The first mold also may have sheet fixing means on the peripheral portion of its molding surface and, if necessary, on other portions.

FIG. 8-(1) shows step (1) of heating a thermoplastic resin foamed sheet to soften it. Because details of this step is the same as those of step (1) of the previously described method according to the first aspect of the present invention, a description of this step is omitted here.

FIG. 8-(2) shows a state where the thermoplastic resin foamed sheet softened in step (1) have been supplied between the first mold having a molding surface through which vacuum sucking can be conducted and the second mold having a molding surface provided with sheet fixing means on at least the peripheral portion of the molding surface.

FIG. 8-(3) shows a state where the molds have been closed until the arrival of the clearance between the peripheral portions of the molding surfaces of the molds at a predetermined value not greater than the softened thermoplastic resin foamed sheet while the softened thermoplastic resin foamed sheet is held with the holding means between the molds and, as a result, the entire area of the molding surface of the second mold has been brought into contact with one surface of the foamed sheet. When the molds are closed until the clearance between the peripheral portions of the molding surfaces of the molds arrives at a predetermined value not greater than the thickness of the foamed sheet, the foamed sheet is fixed on the peripheral portion of the molding surface of the second mold with the sheet fixing means provided on the peripheral portion of the molding surface of the second mold and the entire area of the molding surface of the second mold comes into contact with one surface of the foamed sheet. As a result, the foamed sheet is shaped into the shape of the molding surface of the second mold. Mold closure is carried out so that the opposing molding surfaces of the molds relatively approach to each other. For example, one mold is fixed and the other is moved toward the fixed one. Alternatively, both molds are moved in opposite directions so that the molds approach to each other.

FIG. 8-(4) shows a state where vacuum sucking is carried out through the molding surface of the first mold. The vacuum sucking is started after the coming of the entire area of the molding surface of the second mold into contact with one surface of the foamed sheet. “After the coming of the entire area of the molding surface of the second mold into contact with one surface of the foamed sheet” referred to herein includes “at the same time the entire area of the molding surface of the second mold comes into contact with one surface of the foamed sheet.”When the vacuum sucking is started after the entire area of the molding surface of the second mold comes into contact with one surface of the foamed sheet, it is desirable to start the vacuum sucking before the foamed sheet is cooled and within three seconds from the time when the entire area of the molding surface of the second mold comes into contact with one surface of the foamed sheet.

When a mold having a molding surface through which vacuum sucking can be carried out is used as the second mold, the vacuum sucking through the second mold may be started at any time from step (1) to step (4). In typical cases, vacuum sucking is started when the molds are closed until the clearance between both molds in step (3), becomes equal to or smaller than the thickness of the foamed sheet. By vacuum sucking also through the second mold, it is possible to shape the foamed sheet into the shape of the molding surface of the second mold in a shorter time.

FIG. 8-(5) shows a state where the molds have been opened until the arrival of the thickness of the thermoplastic resin foamed sheet at a predetermined value greater than the thickness of the softened foamed sheet at the start of the step (3) and, thereby, the sheet has been shaped and a molded article has been formed. The opening of the molds are carried out while the vacuum sucking is continued. The speed of the mold opening and the degree of vacuum during the mold opening may be adjusted so that the foamed sheet is held in contact with the molding surfaces of the molds and the foamed sheet is finally shaped into the shape of a desired molded article.

The foamed sheet is fully cooled while the molds are held open with the predetermined clearance. Then, the vacuum sucking is stopped and the molds are further opened. Finally, a resulting molded article is removed. FIG. 8-(6) shows a state where the molds (not shown) have been opened for the removal of the molded article.

It should be understood that the following descriptions are applied to both the embodiments according to the first aspect of the present invention and the embodiments according to the second aspect of the present invention.

In the present invention, a skin material may be placed on the molding surface of one or each mold before the softened foamed sheet is supplied between the molds. The skin material is not particularly restricted with respect to its material and thickness if a foamed sheet can be shaped into the shape of a molding surface by vacuum suction through the skin material. Examples of raw material of the skin material include resin such as thermoplastic resin and thermosetting resin, rubber such as thermoplastic elastomer, natural fiber such as hemp, jute and the like, minerals such as calcium silicate. Examples of the form of the skin material include film, sheet, non-woven fabric and woven fabric. In addition to the materials mentioned above, synthetic paper made of propylene-based resin or styrene-based resin and thin plate or foil of metal such as aluminum and iron may also be used. The skin material may be composed of either one layer or two or more layers. The skin material may be provided with decoration such as uneven pattern e.g. grain pattern, print and dyeing.

The thermoplastic resin foamed sheet for use in the present invention is not particularly restricted. Known foamed sheets may be used.

Examples of the resin for constituting the thermoplastic resin foamed sheet include olefin-based resin such as homopolymers of olefins having 6 or less carbon atoms e.g. ethylene, propylene, butene, pentene and hexene, olefin copolymer produced by copolymerizing of two or more monomers selected from olefins having form 2 to 10 carbon atoms, ethylene-vinyl ester copolymer, ethylene-(meth)acrylic acid copolymer, ethylene-(meth)acrylic ester copolymer, ester resin, amide resin, styrene-based resin, acrylic resin, acrylonitrile-based resin and ionomer resin. These resins may be used either solely or in the form of blend of two or more resins. Among these resins, olefin-based resins are preferably used from the viewpoints of formability, oil resistance and cost. Propylene-based resins are particularly preferably used from the viewpoints of rigidity and heat resistance of resulting molded articles.

When a foamed sheet made of a propylene-based resin is used, examples of the propylene-based resin constituting a foamed layer include propylene homopolymers and propylene-based copolymere containing at least 50 mole % of propylene units. The copolymers may be block copolymers, random copolymers and graft copolymers. Examples of the propylene-based copolymers to be suitably employed include copolymers of propylene with ethylene or an α-olefin having 4 to 10 carbon atoms. Examples of the α-olefin having 4 to 10 carbon atoms include 1-butene, 4-methylpentene-1,1-hexene and 1-octene. The content of the monomer units except propylene in the propylene-based copolymer is preferably up to 15 mole % for ethylene and up to 30 mole % for α-olefins having 4 to 10 carbon atoms. A single kind of propylene-based resin may be used. Alternatively, two or more kinds of propylene-based resin may also be used in combination.

When a long-chain-branching propylene-based resin or a propylene-based resin having a weight average molecular weight of 1×10⁵ or more is used in an amount of 50% by weight or more of the thermoplastic resin forming the foamed layer, it is possible to produce a propylene-based resin foamed sheet containing finer cells. Among such propylene-based resins, non-crosslinked propylene-based resins are preferably used because less gel is formed during a process of recycling sheets.

By the long-chain-branching propylene-based resin used herein is meant a propylene-based resin whose branching index [A] satisfies 0.20≦[A]≦0.98. One example of the long-chain-branching propylene-based resins having a branching index [A] satisfying 0.20≦[A]≦0.98 is Propylene PF-814 manufactured by Basell.

The branching index quantifies the degree of long chain branching in a polymer and is defined by the following formula.
Branching index [A]=[η]_{Br}/[η]_{Lin}
In the formula, [η]_{Br} is the intrinsic viscosity of the long-chain-branching propylene-based resin. [η]_{Lin} is the intrinsic viscosity of a linear propylene-based resin made up of monomer units the same as those of the long-chain-branching propylene-based resin and having a weight average molecular weight the same as that of the long-chain-branching propylene-based resin.

The intrinsic viscosity, which is also called a limiting viscosity number, is a measure of the capacity of a polymer to enhance the viscosity of its solution. The intrinsic viscosity depends especially on the molecular weight and on the degree of branching of the polymer molecule. Therefore, the ratio of the intrinsic viscosity of the long-chain-branching polymer to the intrinsic viscosity of a linear polymer having a molecular weight equal to that of the long-chain-branching polymer can be used as a measure of the degree of branching of the long-chain-branching polymer. The intrinsic viscosity of a propylene-based resin can be determined by a conventionally known method such as that described by Elliott et al., J. Appl. Polym. Sci., 14, 2947-2963 (1970). For example, the intrinsic viscosity can be measured at 135° C. by dissolving the propylene-based resin in tetralin or orthodichlorobenzene.

The weight average molecular weight (Mw) of a propylene-based resin can be determined by various methods commonly used. Particularly preferably employed is the method reported by M. L. McConnel et al. in American Laboratory, May, 63-75 (1978), namely, the low-angle laser light-scattering intensity measuring method.

One example of the method for producing a high-molecular-weight propylene-based resin having a weight average molecular weight of 1×10⁵ or more by polymerization is a method in which a high molecular weight component is produced first and then a low molecular weight component is produced as described in Japanese Patent Application Publication No. 11-228629.

Among the long-chain-branching propylene-based resin and the high-molecular-weight propylene-based resin, preferred is a propylene-based resin having a uniaxial melt elongation viscosity ratio η₅/η_{0.1} of 5 or more, more preferably 10 or more, measured under the conditions given below at about a temperature 30° C. higher than the melting point of the resin. The uniaxial melt elongation viscosity ratio η₅/η_{0.1} is a value measured at an elongation strain rate of 1 sec⁻¹ using a uniaxial elongation viscosity analyzer (for example, a uniaxial elongation viscosity analizer manufactured by Rheometrix), wherein η_{0.1} denotes a uniaxial melt elongation viscosity detected 0.1 second after the start of strain and 5 denotes a uniaxial melt elongation viscosity detected 5 seconds after the start of strain. Use of a propylene-based resin having such a uniaxial elongation viscosity property makes it possible to produce a foamed sheet having more minute cells.

As the foaming agent for use in the preparation of the foamed sheet, either of chemical foaming agents or physical foaming agents may be used. Moreover, both types of foaming agents may be used together. Examples of the chemical foaming agents include known thermally decomposable compounds such as thermally decomposable foaming agents which form nitrogen gas through their decomposition (e.g., azodicarbonamide, azobisisobutyronitrile, dinitrosopentamethylenetetramine, p-toluenesulfonyl hydrazide, p,p′-oxy-bis(benzensulphonyl hydrazide); and thermally decomposable inorganic foaming agents (e.g., sodium hydrogencarbonate, ammonium carbonate and ammonium hydrogencarbonate). Specific examples of the physical foaming agent include propane, butane, water and carbon dioxide gas. Among the foaming agents provided above as examples, water and carbon dioxide gas are suitably employed because foamed sheets produce less deformation caused by secondary foaming during heating in vacuum forming and also because those agents are substances inert under high temperature conditions and inert to fire. The amount of the foaming agent used is appropriately determined on the basis of the kinds of the foaming agent and resin used so that a desired expansion ratio is achieved. However, 0.5 to 20 parts by weight of foaming agent is normally used for 100 parts by weight of thermoplastic resin.

The method for producing the thermoplastic resin foamed sheet for use in the present invention is not restricted. However, extrusion using a flat die (T die) or a circular die is preferred. Particularly preferred is a method in which a molten resin is extruded and simultaneously foamed through a circular die and then the extrudate is stretched and cooled over a mandrel or the like. When the foamed sheet is produced by extrusion, it is also permissive that a molten resin is extruded through a die, cooled to solidify and then stretched. The foamed sheet may be either a unilayer sheet or a multilayer sheet. However, for preventing cells from bursting during the sheet production, a foamed sheet with a multilayer structure having non-foamed surface layers is preferred. The resin for constituting the non-foamed layer(s) may be the resins provided as examples of the resin for forming the foamed layer. The resin of the non-foamed layer(s) is desirably a resin of a type the same as that of the resin forming the foamed layer. For example, when the foamed layer is made of a propylene-based resin, it is desirable that the non-foamed layer(s) be also made of a propylene-based resin.

The thermoplastic resin foamed sheet for use in the present invention may also be a composite sheet prepared by laminating a uni- or multilayer foamed sheet and another material. Such a composite sheet is produced by laminating a foamed sheet and another material by dry lamination, sandwich lamination, heat roll lamination, hot air lamination or the like.

The material which is laminated with a foamed sheet may be selected from materials the same as those previously mentined for the skin material. When automotive interior components are produced by a method of the present invention, sheet or non-woven fabric of thermoplastic resin or natural fiber such as woolen fabrics, hemp and jute are widely used. When food containers are produced, unilayer or multilayer gas barrier film having a layer made of an ethylene-vinyl alcohol copolymer, CPP film, etc. are widely used.

The multilayer thermoplastic resin foamed sheet may be a multilayer foamed sheet composed of a foamed layer and a non-foamed layer. It may also be a multilayer foamed sheet composed of different foamed layers laminated on each other. Examples of the multilayer foamed sheet composed of different foamed layers laminated on each other include those having a foamed layer a having an expansion ratio X_{α} of from 2 to 20, a thickness T_{α} of from 2 to 20 mm, a basis weight R_{α} of from 600 to 3000 g/m² and a foamed layer β having an expansion ratio X_{β} of from 4 to 40, a thickness T_{β} of from 2 to 12 mm, a basis weight R_{β} of from 100 to 600 g/m² wherein R_{α}/R_{β} is from 2 to 30. When such a multilayer thermoplastic resin foamed sheet is vacuum formed by the vacuum forming methods of the present invention, molded articles superior in rigidity and cushioning property can be produced because the foamed layer β expands more than the foamed layer α.

Thermoplastic resin foamed sheets for use in the present invention may contain additives. Examples of the additives include filler, antioxidants, light stabilizers, ultraviolet absorbers, plasticizers, antistatic agents, colorants, release agents, fluidizing agents and lubricants. Specific examples of the filler include inorganic fibers such as glass fiber and carbon fiber and inorganic particles such as talc, clay, silica, titanium oxide, calcium carbonate and magnesium sulfate.

Molded articles produced by the vacuum forming methods of the present invention can be used as packaging materials such as food containers, automotive interior components, building or construction materials and household electrical appliances because they have a high expansion ratio, a large thickness and a light weight and are superior in heat insulation property. Examples of the automotive interior components include door trims, ceilings and trunk side panels. Use of molded articles produced in accordance with the present invention as such components, makes it possible to maintain the temperature inside a car for a long time after the temperature is adjusted. When the molded articles are used as food containers, they are preferably used as containers for soup heated to high temperatures and food containers for cooking in microwave ovens because they can be in various shapes such as cup, tray and bowl and they are superior in heat insulation property.

### EXAMPLES

Described below are examples of the embodiments according to the first aspect of the present invention. The invention, however, is not restricted to the examples.

### Example 1

A two-kind three-layer thermoplastic resin foamed sheet in which a non-foam layer was laminated on each side of a foamed layer was produced by a method described below.

(Material for Forming a Foamed Layer)

0.1 Part by weight of calcium stearate, 0.05 part by weight of phenol-type antioxidant (commercial name: Irganox 1010, manufactured by Ciba Specialty Chemicals, Inc.) and 0.2 part by weight of phenol-type antioxidant (commercial name: Sumilizer BHT, manufactured by Sumitomo Chemical Co., Ltd.) were added to and mixed with 100 parts by weight of a propylene-based polymer powder which was prepared by the method described in Japanese Patent Application Publication No. 11-228629 and which had physical properties shown below. The mixture was melt-kneaded at 230° C. Thus, propylene-based polymer pellets (i) were produced. The melt flow rate (MFR), measured at 230° C. under a load of 2.16 kgf in accordance with JIS K6758, of the propylene-based polymer pellets (i) was 12 g/10 min. The propylene-based polymer pellets (i) were used as a material for forming a foamed layer.

Physical Properties of the Propylene-based Polymer:

The intrinsic viscosity of component (A) (the component having a higher molecular weight of the two components contained in the propylene-based polymer obtained by the method disclosed in Japanese Patent Application Publication No. 11-228629) ([η]A)=8 dl/g; the content of ethylene-deriving units in component (A) (C2inA)=0%; the intrinsic viscosity of component (B) (the component having a lower molecular weight of the two components contained in the propylene-based polymer obtained by the method disclosed in Japanese Patent Application Publication No. 11-228629) ([η]B)=1.2 dl/g; the content of ethylene-deriving units in component (B) (C2inB)=0%. η₅=71,000 Pa·s and η_{0.1}=2,400 Pa·s, measured at a temperature of 180° C. and an elongation strain rate of 0.1 sec⁻¹ using a uniaxial elongation viscosity analyzer manufactured by Rheometrics Co.

(Material for Forming Non-foamed Layer)

Polypropylene (ii) (homopolypropylene FS2011DG2 manufactured by Sumitomo Chemical Co., Ltd., MFR 2.5 g/10 min (230° C., 2.16 kgf)), polypropylene (iii) (long-chain-branching homopolypropylene named PF814 manufactured by Basell, MFR 3 g/10 min (230° C., 2.16 kgf)), polypropylene (iv) (propylene-ethylene random copolymer W151 manufactured by Sumitomo Chemical Co., Ltd., ethylene-deriving structural unit content 4.5% by weight, MFR 8 g/10 min (230° C., 2.16 kgf)), talc masterbatch (v) (block polypropylene-based talc masterbatch MF110 manufactured by Sumitomo Chemical Co., Ltd., talc content 70 wt %), and titanium masterbatch (vi) (titanium masterbatch PPM2924 manufactured by Tokyo Printing Ink Mfg. Co., Ltd., titanium content: 60 wt %, MFR of the random polypropylene base: 30 g/10 min (230° C., 2.16 kgf)) were dry-blended in aweight ratio of (ii)/(iii)/(iv)/(v)/(vi)=12/30/15/43/5 to yield a material for forming a non-foamed layer.

(Production of Foamed Sheet)

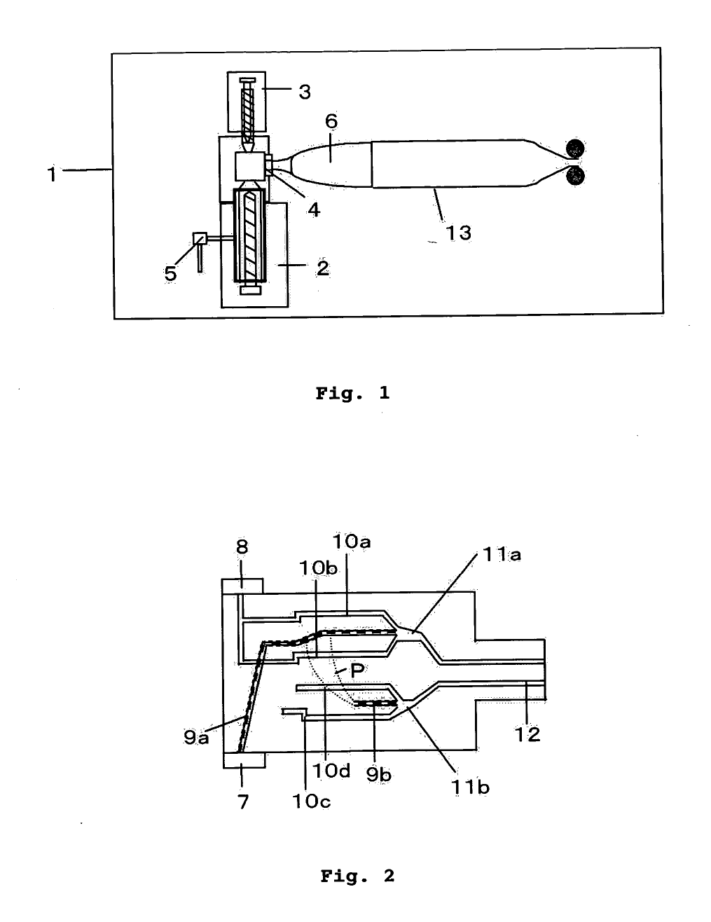

Using the materials for forming a foamed layer and a non-foamed layer described above, extrusion forming was carried out by means of an apparatus (1), shown in FIGS. 1 and 2, in which a 50 mmφ twin screw extruder (2) for extruding a foamed layer and a 32 mm+single screw extruder (3) for extruding a non-foamed layer were connected to a 90 mmφ circular die (4). A thermoplastic resin foamed sheet was produced in the following manner.

A material prepared by blending 0.1 part by weight of a nucleating agent (MB1023 manufactured by Sankyo Kasei Co., Ltd.) to 100 parts by weight of the material for forming a foamed layer was supplied to the 50 mmφ twin screw extruder (2) through a hopper and kneaded in a cylinder heated to 180° C.

When the material for forming a foamed layer and the nucleating agent were melt-kneaded to be fully mixed in the 50 mmφ twin screw extruder (2) and the nucleating agent foamed through thermal decomposition, 0.5 part by weight of carbon dioxide gas as a physical foaming agent was poured from a pump (5) connected to a liquefied carbon dioxide cylinder. After the pouring of carbon dioxide gas, the mixture was further kneaded so that the resinous material was impregnated with carbon dioxide gas. Then, the resulting mixture was fed to the circular die (4).

The material for forming a non-foamed layer was melt-kneaded in the 32 mmφ single screw extruder and then fed to the circular die (4).

The material for forming a foamed layer was introduced into the circular die (4) through a head (7) of the 50 mmφ twin screw extruder and was conveyed toward the outlet of the die through a passageway (9a). On the midway in the passageway (9a), the material was divided through a path P and conveyed also into a passageway (9b).

The material for forming a non-foamed layer was introduced into the die through a head (8) of the 32 mmφ single screw extruder and then divided into passageways (10a) and (10b). After the division, the material was transmitted toward the outlet of the die while being supplied so as to be laminated on both sides of the passageway (9a). At a point (11a), the lamination was achieved. The material for a forming non-foamed layer, which was supplied into the passageways (10a) and (10b), was divided and transmitted into passageways (10c) and (10d) through branching paths (not shown) similar to the path P. Then the material was transmitted toward the outlet of the die while being supplied so as to be laminated on both sides of the passageway (9b). At a point (11b), the lamination was achieved.

The molten resin fabricated into a tubular two-kind three-layer structure at (11a) and (11b) was extruded through the outlet (12) of the circular die (4). The release of the tubular resin to atmospheric pressure allowed the carbon dioxide gas contained in the material for forming a foamed layer to expand to form cells. Thus, a foamed layer was formed.

The two-kind three-layer foamed sheet extruded through the die was stretched and cooled while being drawn over a mandrel (6) having a maximum diameter of 700 mm to form a tube. The resulting tubular foamed sheet was cut along the longitudinal direction at two places to form two flat sheets 1080 mm wide. Each sheet was taken up on a take-up roll. Thus, two thermoplastic resin foamed sheets with an expansion ratio of 3 and a thickness of 1.5 mm were produced.

One of the resulting thermoplastic resin foamed sheets obtained by the method described above was subjected to vacuum molding using a vacuum molding machine (VAIM0301 manufactured by Satoh Machinery Works, Co., Ltd.) as shown in FIG. 3. Both molds (16), (17) were female molds made of epoxy resin. Each mold had a molding surface composed of a square bottom surface sized 300 mm×300 mm and four side surfaces sized 300 mm×0.5 mm. Each mold had a parting face 15 mm wide along with the outer edge of the molding surface. Each mold had, at the four corners and on the four sides of the bottom surface of the molding surface, twelve, in total, vacuum sucking holes with a diameter of 1 mm at 10 cm intervals. The temperatures of the molds were adjusted to 60° C. during the molding.

A foamed sheet (13) was fixed in a clamp frame (14) and then was heated with an infrared heater (15) so that the surface of the sheet reached 160° C. Thus, the sheet was softened. The sheet softened had a thickness of 1.5 mm.

The sheet softened was supplied between the molds (16) and (17) while being fixed in the clamp frame.

The molds (16) and (17) were closed by being caused to approach to each other until the clearance between the parting faces of the molds became 1 mm. Concurrently with the completion of the mold closure, vacuum sucking at a degree of vacuum of −0.09 MPa through the molds was started.

0.5 Second after the start of the vacuum sucking, each mold was opened at a rate of 20 mm/min. Then, the molds were stopped for five seconds at positions where the cavity height, that is to say, the distance between the bottom surfaces of the opposing molding surfaces was 5 mm.

Subsequently, the vacuum sucking was stopped and the molds were opened. Finally, the molded article produced was removed. Results of evaluations of the molded article obtained are shown in Table 1.

### Example 2

Using a foamed sheet the same as that used in Example 1 and a vacuum molding machine similar to that used in Example 1, vacuum molding was carried out as shown in FIG. 4. The molds were structured so that air tightness holding members (18) were formed along the entire circumferences of the parting faces of the molds used in Example 1. Each air tightness holding member (18) was a cushioning material made of foamed rubber, 10 mm in width and 3 mm in thickness. It had a property of being compressed to a thickness of 0.2 mm on mold closure at a surface pressure of 14 MPa. The temperatures of the molds were adjusted to 60° C. during the molding.

The foamed sheet (13) was fixed in a clamp frame (14) and then was heated with an infrared heater (15) so that the surface of the sheet reached 160° C. Thus, the sheet was softened. The sheet softened had a thickness of 1.5 mm.

The sheet softened was supplied between the molds (19) and (20) while being fixed in the clamp frame.

The molds (19) and (20) were closed by being caused to approach to each other until the clearance between the parting faces of the molds became 1 mm. Concurrently with the completion of the mold closure, vacuum sucking at a degree of vacuum of −0.09 MPa through the molds was started.

0.5 Second after the start of the vacuum sucking, each mold was opened at a rate of 20 mm/min. Then, the molds were stopped for five seconds at positions where the cavity height, that is to say, the distance between the bottom surfaces of the opposing molding surfaces was 5 mm.

Subsequently, the vacuum sucking was stopped and the molds were opened. Finally, the molded article produced was removed. Results of evaluations of the molded article obtained are shown in Table 1.

### Example 3

A foamed sheet having an expansion ratio of 5 and a thickness of 1.5 mm was produced by using raw materials and an apparatus the same as those used for the production of the foamed sheet in Example 1 and changing the amount of the physical foaming agent carbon dioxide gas to 1.3 parts by weight. This foamed sheet was subjected to vacuum molding using a vacuum molding machine (VAIM0301 manufactured by Satoh Machinery Works, Co., Ltd.) as shown in FIG. 5. One mold was the mold (17) used in Example 1. The other mold was a mold (22) in which the mold (16) used in Example 1 was provided with an air tightness holding section (21). The temperatures of the molds were adjusted to 60° C. during the molding.

The foamed sheet (13) was fixed in a clamp frame (14) and then was heated with an infrared heater (15) so that the surface of the sheet reached 160° C. Thus, the sheet was softened. The sheet softened had a thickness of 1.5 mm.

The sheet softened was supplied between the molds (22) and (17) while being fixed in the clamp frame.

The molds (22) and (17) were closed by being caused to approach to each other until the clearance between the parting faces of the molds became 1 mm. Concurrently with the completion of the mold closure, vacuum sucking at a degree of vacuum of −0.09 MPa through the molds was started.

0.5 Second after the start of the vacuum sucking, each mold was opened at a rate of 20 mm/min. Then, the molds were stopped for five seconds at positions where the cavity height, that is to say, the distance between the bottom surfaces of the opposing molding surfaces was 6 mm.

Subsequently, the vacuum sucking was stopped and the molds were opened. Finally, the molded article produced was removed. Results of evaluations of the molded article obtained are shown in Table 1.

### Example 4

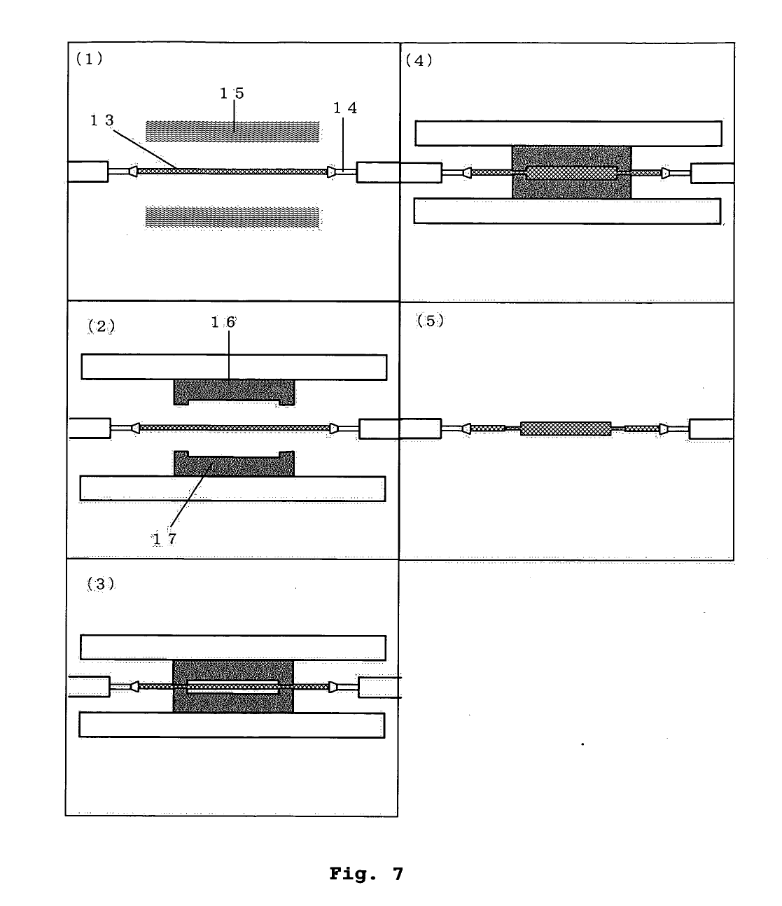

Using a foamed sheet the same as that used in Example 3 and a vacuum molding machine similar to that used in Example 3, vacuum molding was carried out as shown in FIG. 6. One mold was the mold (20) used in Example 2 which had an air tightness holding section (18). The other mold was a mold (23) in which the mold (19) used in Example 2 was provided with an air tightness holding section (21) along the periphery of the mold (19). The temperatures of the molds were adjusted to 60° C. during the molding.

The foamed sheet (13) was fixed in a clamp frame (14) and then was heated with an infrared heater (15) so that the surface of the sheet reached 160° C. Thus, the sheet was softened. The sheet softened had a thickness of 1.5 mm.

The sheet softened was supplied between the molds (20) and (23) while being fixed in the clamp frame.

The molds (20) and (23) were closed by being caused to approach to each other until the clearance between the parting faces of the molds became 1 mm. Concurrently with the completion of the mold closure, vacuum sucking at a degree of vacuum of −0.09 MPa through the molds was started.

0.5 Second after the start of the vacuum sucking, each mold was opened at a rate of 20 mm/min. Then, the molds were stopped for five seconds at positions where the cavity height, that is to say, the distance between the bottom surfaces of the opposing molding surfaces was 6 mm.

Subsequently, the vacuum sucking was stopped and the molds were opened. Finally, the molded article produced was removed. Results of evaluations of the molded article obtained are shown in Table 1.

### Comparative Example 1

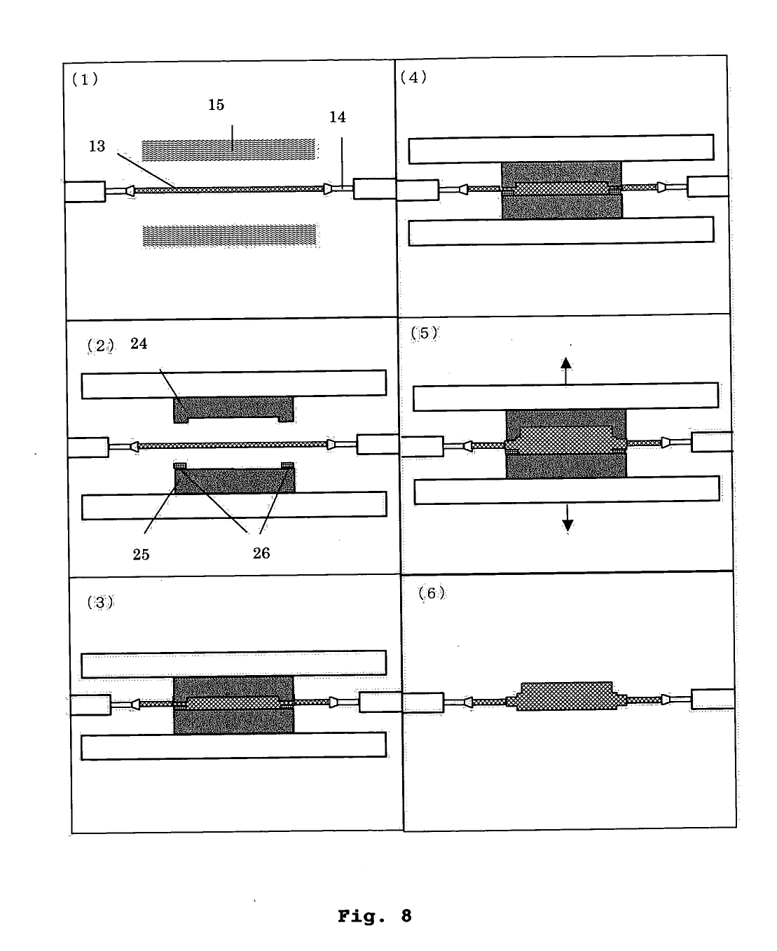

Using a foamed sheet and molds the same as those used in Example 1, vacuum molding was carried out as shown in FIG. 7. The temperatures of the molds were adjusted to 60° C. during the molding.

The foamed sheet (13) was fixed in a clamp frame (14) and then was heated with an infrared heater (15) so that the surface of the sheet reached 160° C. Thus, the sheet was softened. The sheet softened had a thickness of 1.5 mm.

The sheet softened was supplied between the molds (16) and (17) while being fixed in the clamp frame.

The molds (16) and (17) were closed by being caused to approach to each other until the clearance between the parting faces of the molds became 1 mm. Concurrently with the completion of the mold closure, vacuum sucking at a degree of vacuum of −0.09 MPa through the molds was started and then the vacuum sucking state was held for 10 seconds.

Subsequently, the vacuum sucking was stopped and the molds were opened. Finally, the molded article produced was removed. Results of evaluations of the molded article obtained are shown in Table 2.

### Comparative Example 2

A foamed sheet the same as that used in Example 1 was subjected to vacuum molding. Both molds were female molds made of epoxy resin. Each mold had a molding surface composed of a square bottom surface sized 300 mm×300 mm and four side surfaces sized 300 mm×2 mm. Each mold had a parting face 15 mm wide along with the outer edge of the molding surface. Each mold had, at the four corners and on the four sides of the bottom surface of the molding surface, twelve, in total, vacuum sucking holes with a diameter of 1 mm at 10 cm intervals. The temperatures of the molds were adjusted to 60° C. during the molding.

The foamed sheet (13) was fixed in a clamp frame (14) and then was heated with an infrared heater (15) so that the surface of the sheet reached 160° C. Thus, the sheet was softened. The sheet softened had a thickness of 1.5 mm.

The sheet softened was supplied between the molds while being fixed in the clamp frame.

The molds were closed by being caused to approach to each other until the clearance between the parting faces of the molds became 1 mm. Concurrently with the completion of the mold closure, vacuum sucking at a degree of vacuum of −0.09 MPa through the molds was started and then the vacuum sucking state was held for 10 seconds.

Subsequently, the vacuum sucking was stopped and the molds were opened. Finally, the molded article produced was removed. The resulting molded article had deep unevenness in the surface due to deflation caused by burst of cells and, therefore, was not shaped into the shapes of the mold surfaces. Results of evaluations of the molded article obtained are shown in Table 2.

### Comparative Example 3

Vacuum molding was carried out in the same manner as Comparative Example 2 except using a foamed sheet the same as that used in Example 3. The resulting molded article had deep unevenness in the surface due to deflation caused by burst of cells and, therefore, was not shaped into the shapes of the mold surfaces. Results of evaluations of this molded article are shown in Table 2.

(Measurement of Expansion Ratio)

A product sampled in a size 20 mm×20 mm was measured for the specific gravity by means of an immersion-type densimeter (Automatic Densimeter, D-H100, manufactured by Toyo Seiki Seisaku-Sho Co., Ltd.) The expansion ratio was calculated on the basis of the densities of the materials forming the product.

(Evaluation of Heat Transmission Coefficient)

A thermal conductivity was measured in accordance with JIS A-1412 using a thermal conductivity tester (AUTO-Λ series HC-074) manufactured by Eko Instruments Co., Ltd. On the basis of the measurement, a heat transmission coefficient was calculated. The measurement conditions are as follows: low temperature plate temperature: 20° C., high temperature plate temperature: 30° C. The smaller the coefficient of heat transmission, the better the heat insulation property.

TABLE 1

| | Example 1 | Example 2 | Example 3 | Example 4 |
|---|---|---|---|---|
| Thickness of | 1.5 | 1.5 | 1.5 | 1.5 |
| unprocessed sheet (mm) | | | | |
| Expansion ratio of | 3 | 3 | 5 | 5 |
| unprocessed sheet | | | | |
| Thickness of molded | 4.5 | 5 | 5 | 6 |
| article (mm) | | | | |
| Expansion ratio of | 9 | 10 | 17 | 20 |
| molded article | | | | |
| Appearance of molded | good | good | good | good |
| article | | | | |
| Heat transmission | 12 | 11 | 10 | 8 |
| coefficient (W/m²/K) | | | | |

TABLE 2

| | Comparative | Comparative | Comparative |
|---|---|---|---|
| | Example 1 | Example 2 | Example 3 |
| Thickness of | 1.5 | 1.5 | 1.5 |
| unprocessed sheet (mm) | | | |
| Expansion ratio of | 3 | 3 | 5 |
| unprocessed sheet | | | |
| Thickness of molded | 2 | 2-4*¹ | 2-4*¹ |
| article (mm) | | | |
| Expansion ratio of | 4 | 4-8*¹ | 7-13*¹ |
| molded article | | | |
| Appearance of molded | good | poor | poor |
| article | | | |
| Heat transmission | 28 | 25 | 22 |
| coefficient (W/m²/K) | | | |

*¹The molded articles of Comparative Examples 2, 3 were of great locational variations with respect to both thickness and expansion ratio.

What is claimed is:

1. A method for producing a thermoplastic resin foamed article by vacuum forming using a molding apparatus comprising a pair of molds each having a molding surface through which vacuum sucking can be conducted and holding means for holding a thermoplastic resin foamed sheet at a predetermined position between the molds, the method comprising the steps of:
(1) heating a thermoplastic resin foamed sheet to soften it;
(2) supplying the thermoplastic resin foamed sheet softened in step (1) between the molds;
(3) while holding the softened thermoplastic resin foamed sheet with the holding means between the molds, closing the molds until a clearance between the peripheral portions of the molding surfaces of the molds arrives at a predetermined value not greater than the softened thermoplastic resin foamed sheet;
(4) starting vacuum sucking through the molding surfaces of the molds at a point of time during a period from the arrival of the clearance between the peripheral portions of the molding surfaces of the molds at the thickness of the softened thermoplastic resin foamed sheet to the arrival of the clearance at the predetermined value defined in step (3);
(5) while continuing the vacuum sucking, opening the molds until the thermoplastic resin foamed sheet comes to have a predetermined thickness greater than the softened thermoplastic resin foamed sheet at the beginning of step (3), thereby shaping the sheet to produce a molded article; and
(6) a combination of stopping the vacuum sucking, opening the molds and removing the molded article.

2. A method for producing a thermoplastic resin foamed article by vacuum forming using a molding apparatus comprising a first mold having a molding surface through which vacuum sucking can be conducted, a second mold having a molding surface provided with sheet fixing means on at least the peripheral portion of the molding surface, and holding means for holding a thermoplastic resin foamed sheet at a predetermined position between the molds, the method comprising the steps of:
(1) heating a thermoplastic resin foamed sheet to soften it;
(2) supplying the thermoplastic resin foamed sheet softened in step (1) between the first and second molds;
(3) while holding the softened thermoplastic resin foamed sheet with the holding means between the molds, closing the molds until a clearance between the peripheral portions of the molding surfaces of the molds arrives at a predetermined value not greater than the softened thermoplastic resin foamed sheet, thereby bringing the entire area of the molding surface of the second mold into contact with one surface of the foamed sheet;
(4) starting vacuum sucking through the molding surface of the first mold after the entire area of the molding surface of the second mold comes into contact with the surface of the foamed sheet in step (3);
(5) while continuing the vacuum sucking and fixing the sheet on the molding surface of the second mold with the sheet fixing means, opening the molds until the thermoplastic resin foamed sheet comes to have a predetermined thickness greater than the thickness of the softened thermoplastic resin foamed sheet at the beginning of step (3), thereby shaping the sheet to produce a molded article; and
(6) a combination of stopping the vacuum sucking, opening the molds and removing the molded article.
